(19) United States
(12) Patent Application Publication
(10) Pub. No.: US 2005/0091959 A1
(43) Pub. Date: May 5, 2005

(54) Baler

(75) Inventors: Jean Viaud, Gray (FR); Emmanuel Chapon, Velet (FR)

Correspondence Address: Jimmie R. Oaks;Patent Department, DEERE & COMPANY, One John Deere Place, Moline, IL, 61265-8098, US

(73) Assignee: Deere & Company, a Delaware corporation.

(21) Appl. No.: 10/935,814

(22) Filed: Sep. 7, 2004

(30) Foreign Application Priority Data
Oct. 30, 2003 (DE) 103 50 622.5

(51) Int. Cl. A01D 39/00

(52) U.S. Cl. 56/341

(57) ABSTRACT

A large round baler includes a device for introducing a wrapping web to the baling chamber for wrapping a bale with the wrapping web. During a wrapping procedure, the wrapping web is pulled off a supply roll and directed to a location in front of the baling chamber where it is engaged by a crop supply unit and introduced into the baling chamber where the rotating bale carries the wrapping web about it and becomes wrapped.

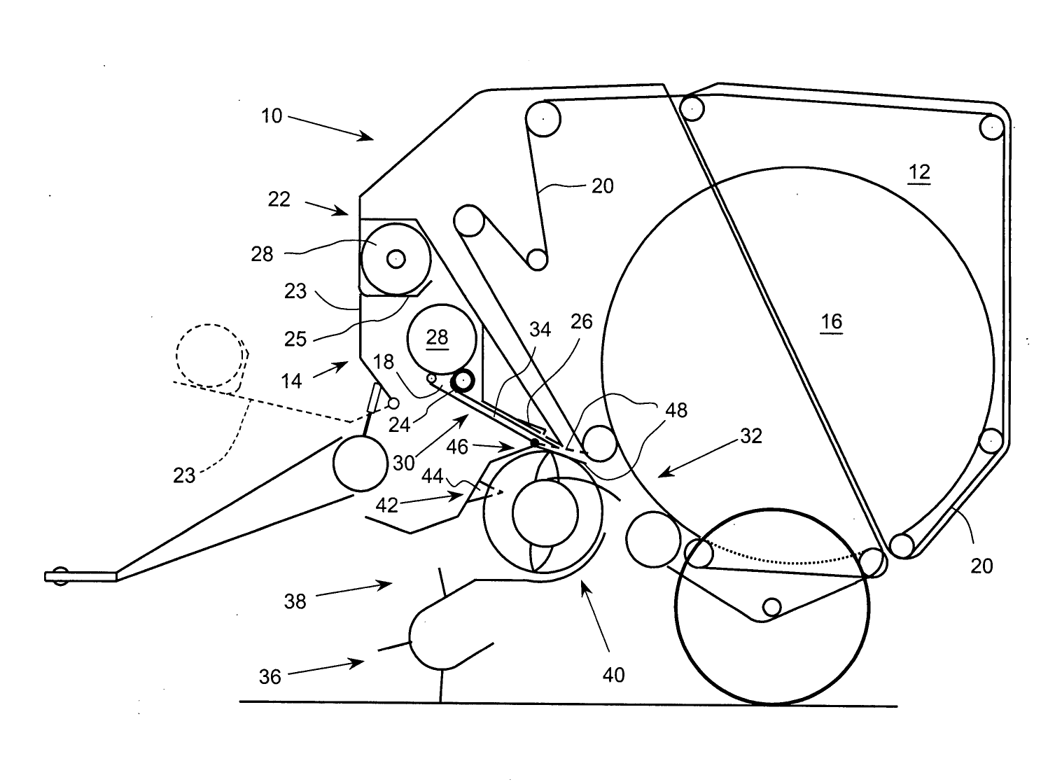

### FIELD OF THE INVENTION

The invention pertains to a baler with a baling chamber, a crop material supply unit that can convey crop material to the baling chamber, and a device for wrapping a bale with a wrapping web, which has means that pull a wrapping web off a supply in the nature of a roll, for instance.

### BACKGROUND OF THE INVENTION

DE-C2-36 17 155 shows a round baler with a device for wrapping a bale with a wrapping web and having a feed mechanism that first draws off the wrapping web from a supply in order then to lay it down on a hold-down device and bring it up to a starting roll that seizes the wrapping web and supplies it to the bale to be wrapped.

The problem underlying the invention is seen in the fact that such a baler with a device for wrapping a bale comprises many individual parts for supplying the wrapping web to the bale and is thus expensive to manufacture and maintain.

### SUMMARY OF THE INVENTION

According to the present invention, there is provided a large round baler having a novel web delivery arrangement for introducing a web of material into the baling chamber.

An object of the invention is to provide a web delivery arrangement which comprises an economical combination of separate parts.

A baler is shown with a baling chamber, a crop material supply unit that can convey crop material into the baling chamber and a device for wrapping a bale with a wrapping web, which has a means that draw off a wrapping web from a supply in the nature of a roll, for instance, the device being able to bring the wrapping web to the crop material supply unit such that it is seized thereby and conveyed in the direction of the bale. In this way, it is possible to forgo supply mechanisms that bring the wrapping web to the bale so that it can be seized by the bale, since this function is already fulfilled in essence by the crop material supply unit. During the actual formation of the bale, the crop material supply unit serves to convey crop material into the baling chamber. During the wrapping process, on the other hand, it conveys the wrapping web in the direction of the bale.

The crop material supply unit preferably involves a conveyor rotor designed in the usual manner which is equipped with driving elements that convey crop material into the baling chamber of the baler. The crop material supply unit can also be constructed as a belt conveyor, a conveyor auger, a conveyor roller, or in any other suitable manner.

By virtue of a guide unit, constructed preferably in the manner of a channel and/or a guide surface that extends from the web feed roller up to the crop material supply unit, the supply of the wrapping web to the bale can be further improved, since a contact between the wrapping web and baling material and/or, in particular, moving components of the baler is counteracted. The guide unit can be constructed in the form of a channel that is essentially closed off at least on the top and the bottom, but it can also be a guide surface, preferably provided underneath the wrapping web.

In particular, the guide unit can be arranged in edge areas of the wrapping web, where it forms a kind of directional device. Preferably, however, it extends over at least substantially the entire width of the wrapping web.

If the device interacts with a blower or comprises a blower, then it is possible to provide for the latter to generate an air stream that conveys or pushes the wrapping web in the direction of the conveyance unit.

If the guide unit or the channel or the guide surface interacts with the blower, then the air stream is concentrated by the channel or directed by the guide surface, whereby a targeted guidance of the wrapping web is supported. Additionally, by forming an air cushion on which the wrapping web hovers, the air stream prevents the wrapping web from contacting the channel or a wall of the channel or the guide surface and sticking there. This is particularly favorable if the wrapping web is coated with an adhesive or has adhesive characteristics. It can be provided for the blower to supply the air stream at least over substantially the entire width of the channel by means, for instance, of a supply slit or the like, which yields a uniform distribution. It is also possible for the air introduction to be done over areas or points so as to deliberately advance or lift off the channel certain areas of the wrapping web, which can also be constructed in a special manner for propulsion by an air stream, for instance, by being un-perforated, while the rest of the wrapping web is perforated.

It can be provided for the wrapping web to detach after termination of the wrapping process, for instance, by having the bale continue to rotate while the feeding of wrapping web from the supply is interrupted. To achieve a uniform detachment edge and thus counteract any tangling of the wrapping web, a cutoff unit can be provided, comprising for instance a blade that cuts or detaches the wrapping web. This cutoff unit can interact with the guide unit in such a manner that the latter serves to back up the wrapping web or hold it in place.

If the crop material supply unit interacts with a cutting unit, then the crop material conveyed by the crop material supply unit is further comminuted by the cutting unit, whereby a more uniform bale is formed. The crop material supply unit and the cutting unit are preferably arranged in a supply channel of the baler, through which the crop material taken up by a take-up unit reaches a baling chamber of the baler, in which the bale is formed and then wrapped.

The crop material supply unit can simply be arranged adjoining the baling chamber that accommodates the bale; between the crop material supply unit and the baling chamber, it is a also possible for additional conveying units to be provided; these may be in the nature of a starter roller or in the nature of belts, which contribute to the bale formation or are provided independently thereof.

The crop material supply unit can be arranged downstream of a take-up unit that takes up material to be baled from the ground. Such a take-up unit can be a conventional pick-up, for example. It is also conceivable, however, for it to be constructed in a different manner, for instance, in the nature of a conveyor belt.

It is possible for the wrapping web to be brought to the crop material supply unit purely by its weight or by an air stream generated by a blower, etc, in order to begin the wrapping process, and then to be separated from the crop material supply unit by an appropriate detachment or cutoff when the baling process has been or is to be terminated. It is also possible, however, for a guide means to be provided that selectively brings the wrapping web up to the crop material supply unit. The guide means can bring the wrapping web up to the crop material supply unit so that it can be seized by the latter. After termination of the wrapping process, or in order to terminate it, the guide means removes the wrapping web from the crop material supply unit so that it is no longer conveyed by the crop material supply unit or can no longer be seized by the latter.

The guide means can be constructed, for example, as a guide plate on which the wrapping web lies. If the guide means is constructed like a rake, then the wrapping web can lie on the guide means or the tines of the rake, and be brought thereby to the crop material supply unit and removed there from. Dirt and contaminants can fall between the tines of the rake, so that deposits on the guide means are counteracted. Additionally, a rake-like or partially cut-out design of the guide means offers the possibility for the wrapping web to be seized by the crop material supply unit while still lying on the guide means, which favors a good conveyance, particularly at the beginning of the wrapping process.

If the crop material supply unit is arranged in a supply channel that extends between the take-up unit and the baling chamber and through which the gathered material is conveyed by the crop material supply unit into the baling chamber, then the guide means can be provided at an end area of the supply channel facing the baling chamber, or can be directly or indirectly connected to that area.

The guide means can be provided to be generally movable, so as to bring the wrapping web into at least a first position separated from the crop material supply unit and a second position in which the guide means adjoins the crop material supply unit or, particularly in case of a rake-like design, engages with it. It is simple and easy to service if the guide means is provided to be pivotable. In order to pivot the guide means, it can be connected to a motor in the nature of, for example, an electric or hydraulic motor, directly or indirectly, via levers, for instance.

The crop material supply unit can employ overshot or undershot conveyance. In case of overshot conveyance, wrapping web is preferably supplied from above. In case of undershot conveyance, a supply from below is favorable, where the wrapping web can be brought by the guide means from below up to the crop material supply unit so that it can be seized by the later and conveyed into the baling chamber.

A device for wrapping bales can find application in industry on balers that form bales of paper, wastes, textile materials, and so on. Such a device is particularly suited, however, for use on an agricultural baler for bales of agricultural crops that is usually towed by a tractor vehicle; more particularly it is suited for round balers, since these must be structurally simple and operationally secure to survive in harvesting use.

### BRIEF DESCRIPTION OF THE DRAWINGS

An embodiment of the present invention is represented below in the drawing.

The sole FIGURE shows a schematic representation of a baler with a device for wrapping a bale with a wrapping web.

### DESCRIPTION OF THE PREFERRED EMBODIMENT

The sole FIGURE shows a baler 10 of essentially conventional construction with baling chamber 12. Corresponding to the present embodiments, a wrapping material supply arrangement 14 I for wrapping a bale 16 formed in baling chamber 12 with a wrapping web 18 is additionally provided.

Baler 10 may be of a conventional design, that is, with a baling chamber 12 of constant or variable size that is surrounded by rollers, by chains or by a combination of belts and chains or, as in this embodiment, by belts 20.

Such a baler 10 can be employed in agriculture for forming bales 16 of crop material, such as straw, hay or grass. Usage in industrial fields is also conceivable, however.

Wrapping material supply arrangement 14 I is provided in the present embodiment at the front end of baler 10. Wrapping web 18 is supplied through a gap between two adjacent belts 20 to baling chamber 12, where it is entrained by the rotating bale 16. Wrapping material supply arrangement 14, however, can also be arranged in a central area of baler 10, or also in front of or above baling chamber 12.

By means of wrapping web 18, bale 16 is tied up and thus prevented from falling apart after leaving baler 10. Wrapping web 18 can be a film, a net, textile, paper or the like.

Wrapping material supply arrangement 14 comprises a housing 22, feed means that supply wrapping web 18 to bale 16, or a feed element constructed in this example as a feed roller 24 and a cutoff unit 26. Wrapping web 18 is stored in housing 22 as a roll 28 or a supply. Housing 22 can also be constructed such that it stores several rolls 28 and/or comprises steps or depressions for holding them in position. In the present embodiment, housing 22 comprises a flap 23 which is mounted to a location on the baler frame vertically beneath the housing 22 for pivoting about a horizontal transverse axis between an upper operating position, wherein it is joined to the remainder of housing 22 and can close off housing 22, and a lowered loading position, shown in dashed lines, wherein the reserve supply roll can be accessed and manually placed in an operative position and wherein a new reserve roll can be loaded into the housing 22. Flap 23 is provided with an intermediate bottom 25 that is constructed such that it provides a resting place for an additional roll 28 that can be carried along as an extra supply in baler 10. Flap 23 can be brought manually or automatically or by motor power, with the aid, for example, of a hydraulic cylinder, in the form, for instance, of a motor or a damper, into the lowered loading position.

The feed element or feed roller 24 is provided on its circumferential surface with a coating having a high coefficient of friction and can be set into rotation. Initially, the rotation helping to draw wrapping web 18 off roll 28 and, during the wrapping process, it builds up a tension in the web due to a braked rotational motion. In its operating position, roll 28 comes into contact with feed roller 24 at an area that corresponds to roughly a four to six o'clock position.

Additionally, wrapping material supply arrangement 14 comprises a guide unit 30 which guides wrapping web 18 in the direction of a gap 32 between adjacent belts 20.

Guide unit 30 is constructed in the form of a shallow channel 34 extending over the entire width of wrapping web 18 and closed at the sides; it extends approximately into gap 32. Alternatively, a guide unit could be provided only underneath wrapping web 18, for example, in the form of a guide sheet.

On channel 34, it is possible to provide one or more blowers that blow air directly or via tubes, lines, etc. into channel 34 to convey wrapping web 18 in the direction of bale 16 or to counteract adhesion of the wrapping web 18 to channel 34 by forming an air cushion in channel 34 on which the wrapping web 18 hovers, particularly if the wrapping web 18 is coated with an adhesive or is constructed to be self-adhesive.

Alongside this wrapping material supply arrangement 14, baler 10 comprises a take-up unit 36 in the nature of a conventional pickup, which takes up cut crop material from the ground and brings it into a supply channel 38. A conveyor rotor with driving elements or a crop material supply unit 40, which conveys the crop material supplied by take-up unit 36 into baling chamber 12, is provided in the supply channel 38.

Crop material supply unit 40 also interacts in a conventional manner with a cutting unit 42, which is provided in supply channel 38 above crop material supply unit 40, but could also be positioned below crop material supply unit 40 or elsewhere. Cutting unit 42 comprises a plurality of blades 44 that penetrate the conveyance area of crop material supply unit 40 so as to comminute the crop material further.

In an upper end area 46 of supply channel 38 facing baling chamber 12, a pivotable material guide 48 is provided. The material guide 48 interacts with the wrapping web 18 brought in from channel 34 and is designed in the manner of a rake. Material guide 48 is shown in the figure pivoted down in an operating position (solid line) and in a non-operating position (broken line).

The wrapping web 18 coming from channel 34 is taken up by material guide 48 at the end of channel 34. If material guide 48 is in its lowered position, wrapping web 18 is seized by crop material supply unit 40, employing overshot conveyance in the illustrated embodiment, and led into baling chamber 12, where wrapping web 18 is in turn seized by rotating bale 16 so as to wrap it.

If material guide 48 is in its upper, non-operating position, on the other hand, in which it or its tines are some distance away from crop material supply unit 40, wrapping web 18 is not seized by crop material supply unit 40 and thus not brought to the bale 16, so that no wrapping process of bale 12 takes place.

The mode of operation of baler 10 or wrapping material supply arrangement 14 will be briefly summarized below.

By means of supply device 36, crop material is conveyed via supply channel 38 and crop material supply unit 40 into the baling chamber 12 of baler 10, where it is compacted by belts 20 into a bale 16. After the bale formation has finished, as determined, for instance, by one or more sensors detecting the bale size, a time controller, a determination of the flow amount and so on, wrapping material supply arrangement 14 is activated so as to wrap bale 16 with wrapping material 18. This activation can be done, for example, by means of a control or regulation unit, not shown, that can be provided on baler 10 itself or on a towing vehicle such as a farm tractor. To start the wrapping process, feed roller 24 is set into rotation to pull wrapping material off roll 28. Wrapping material 18 moves into channel 34 and is conveyed by the action of the feed roller 24 and the above-described blower action, if present, in the direction of baling chamber 12 or bale 16. Additionally, material guide 48, which is actively connected to an electric motor or a hydraulic motor, is brought into its lowered position, shown with a solid line, in which it becomes engaged with the crop material supply unit 40 or is positioned adjacent thereto. The wrapping web 18, which emerges from channel 34 and is now lying on the material guide 48, is brought by crop material supply unit 40 between adjacent belts 20 into baling chamber 12, where it is seized by rotating bale 16 and becomes wrapped about the bale. It can be advantageous to deactivate take-up device 36 during the wrapping process, or in general to inhibit a supply of crop material to crop material supply unit 40 to guarantee an optimal feeding of the wrapping web 18.

If the wrapping process of bale 16 has terminated, which can be determined by conventional sensors or also by a timer controller, etc., wrapping web 18 is cut through by means of a cutoff unit 26 pivotably arranged on channel 34, and material guide 48 is brought back to its raised position (broken line) and thus wrapping material 18 is brought out of engagement with crop material supply unit 40, whereby no further wrapping material 18 is supplied to baling chamber 12.

Subsequent thereto, the finished bale 16 is ejected from baler 10.

It is pointed out here that the use of material guide 48, or of a material guide 48 constructed in the form of a rake, is not absolutely necessary to the invention. Rather, it is possible to forgo material guide 48 entirely, particularly with a suitable controlling of feed roller 24 for pulling the wrapping web off roll 28 and/or a suitable arrangement of cutoff unit 26.

In a second embodiment, the present invention is used with a crop material supply unit employing undershot conveyance. For this purpose, the wrapping material is supplied in an area situated essentially below baling chamber 12 in order to be seized by it as described above and brought to the bale, so that the wrapping material can be seized by the bale. To guide the wrapping material up to the crop material supply unit in this manner, one or more blowers, for example, can be used in the manner described in the first embodiment. The use of mechanical supply means in the nature of supply means engaging with the wrapping web, such as additional rotors, belt conveyors, etc. is also conceivable. For such an embodiment it is advantageous if the opening through which the wrapping web reaches the crop material supply unit is at least substantially closed during the actual formation of the bale so as to counteract the intrusion of crop material.

Having described the preferred embodiment, it will become apparent that various modifications can be made without departing from the scope of the invention as defined in the accompanying claims.

1. In a large round baler having a baling chamber, a crop material supply unit that can convey crop material into baling chamber and a device for supplying a wrapping web for wrapping a bale formed within the baling chamber, with the device including a wrapping web feed arrangement that draws a wrapping web off a supply roll, the improvement comprising: said device being operable for bringing a wrapping web into engagement with said crop material supply unit, whereby the wrapping web is seized by said crop material supply unit and conveyed into engagement with said bale.

2. The baler, as defined in claim 1, wherein said crop material supply unit is a conveyor rotor including driving element.

3. The baler, as defined in claim 1, wherein in said device for supplying a wrapping web further includes a guide unit including a guide surface extending at least substantially from said wrapping web feed arrangement up to said crop material supply unit.

4. The baler, as defined in claim 3, wherein said guide surface extends at least substantially across an entire width of said wrapping web.

5. The baler, as defined in claim 3, and further including a cutoff unit which interacts with said guide unit.

6. The baler, as defined in claim 1, wherein said crop material supply unit is arranged adjacent said baling chamber.

7. The baler, as defined in claim 6, and further including a crop take-up unit located for delivering crop to said crop material supply unit.

8. The baler, as defined in claim 3, wherein said guide unit includes at least one section mounted for being selectively moved between a first position for delivering said wrapping web to said crop material supply unit, and a second position moved away from said crop material supply unit.

9. The baler, as defined in claim 8, wherein said one section is constructed in the manner of a rake.

10. The baler, as defined in claim 8, wherein said one section is located adjacent an inlet to said baling chamber.
